(19) United States
(12) Patent Application Publication
(10) Pub. No.: US 2007/0130824 A1
(43) Pub. Date: Jun. 14, 2007

(54) Raised-bed gardening system

(76) Inventor: Mark Teich, South Salem, NY (US)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/297,223

(22) Filed: Dec. 8, 2005

(51) Int. Cl. A01G 25/00

(52) U.S. Cl. 47/21.1; 47/79

(57) ABSTRACT

A raised-bed gardening system, including a raised-bed gardening structure and an integrated water-delivery system. The gardening structure has a frame, including a base, vertical support members, and cross members that define a gardening enclosure. A grid assembly is connected to the base and a fence is connected to the frame to form a protective barrier to keep unwanted pests out of the garden. The fence preferably includes a gate, to provide the gardener access to the garden. Raised garden beds are arranged within the gardening enclosure adjacent to walkways so that each bed can be readily attended to from the walkways. In an alternate embodiment, the gardening structure is wheelchair accessible.

### BACKGROUND OF THE INVENTION

1. Field of the Invention

The present invention relates to a raised-bed gardening structure. More particularly the present invention relates to a raised-bed, self-irrigating gardening structure that protects a garden from pests, and that is completely free standing and can be portable.

2. Description of the Related Art

Raised garden beds are well known in the prior art, and provide many advantages over non-raised garden beds. Raised beds permit precise control of soil conditions, and allow the gardener to grow a greater variety of plants than otherwise might be possible. Raised beds provide better water drainage and less soil compaction, resulting in a more productive garden.

Raised beds also provide substantial benefits to the gardener. Garden beds that are above ground level reduce the risk of back injury, and facilitate cultivation especially in climates with cool or wet weather.

Keeping unwanted pests out of a garden is essential for a healthy and productive garden. Although a raised-bed garden offers slightly better protection from pests than a traditional garden, a raised bed alone does not solve this problem. Fencing is often needed to prevent pests from eating or otherwise destroying the plants being grown in the garden. Fencing must be tailored to the type of pest the gardener wishes to keep out; selecting, installing, and maintaining the proper type of fencing can be a confusing and labor-intensive process.

Plants in a garden must get the right amount of water and sunlight to thrive. Traditional watering methods involve dragging hose and setting up sprinklers, which is often cumbersome and time consuming. Precisely controlling the amount of water given to a group of plants can be difficult, since plants with different water needs are often grown in close proximity. Additionally, the gardener may find that it becomes necessary to change the location of the garden because tree growth obscures the sun or for other reasons. Moving a traditional garden plot to a new area has been extremely difficult if not impossible.

The present invention addresses all of these problems by providing a raised-bed gardening system including raised garden beds, an integrated watering system, and a protective barrier that prevents both large and small pests from destroying the garden. The raised-bed gardening system also allows for removal and relocation of the gardening system if required.

### SUMMARY OF THE INVENTION

It is an object of the present invention to provide a raised-bed gardening structure.

It is another object of the present invention to provide a raised bed gardening structure with an integrated watering system that allows each garden bed to be watered independently if desired.

It is yet another object of the present invention to provide a raised-bed gardening structure surrounded by a fence to keep out animals.

It is still another object of the present invention to provide a raised-bed gardening structure sitting on a heavy-gauge wire welded grid connected to the perimeter of the garden to create a protective seal that prevents animals from burrowing up through the bottom of the garden.

It is a further object of the present invention to provide a raised-bed gardening structure that can be assembled using basic household hand and power tools.

It is still a further object of the present invention to provide a raised-bed gardening structure that can be wheelchair accessible.

It is still a further object of the present invention to provide a raised-bed gardening structure that is freestanding, so that the structure can be taken apart and relocated if required.

These and other objects and advantages are achieved by a raised-bed gardening system of the present invention that includes a raised-bed gardening structure and, preferably a water-delivery system. The gardening structure has a frame with a perimeter. The frame includes a base, a plurality of vertical support members connected to the base, a plurality of cross members connected to the vertical support members, and a grid assembly connected to the base. A fence is connected to the perimeter of the frame to form, along with the grid assembly, a gardening enclosure. A plurality of interconnected sidewalls are positioned above the grid assembly to form at least one raised garden bed and at least one walkway.

### BRIEF DESCRIPTION OF THE DRAWINGS

FIG. 1 illustrates a front perspective view of an exemplary embodiment of the raised-bed gardening system according to the present invention;

FIG. 2 illustrates a plan view of the raised-bed gardening system of FIG. 1;

FIG. 3 illustrates a cross-sectional, cut-out view of the raised bed gardening system of FIG. 1;

FIG. 4 illustrates a top view of the watering system of the raised-bed gardening system of FIG. 1;

FIG. 4A illustrates a front view of the watering system of FIG. 4;

FIG. 5 illustrates the removable trellis rack of the raised-bed gardening system of FIG. 1; and

FIG. 6 illustrates a plan view of the top of the frame of the raised-bed gardening system of FIG. 1.

### DETAILED DESCRIPTION OF THE INVENTION

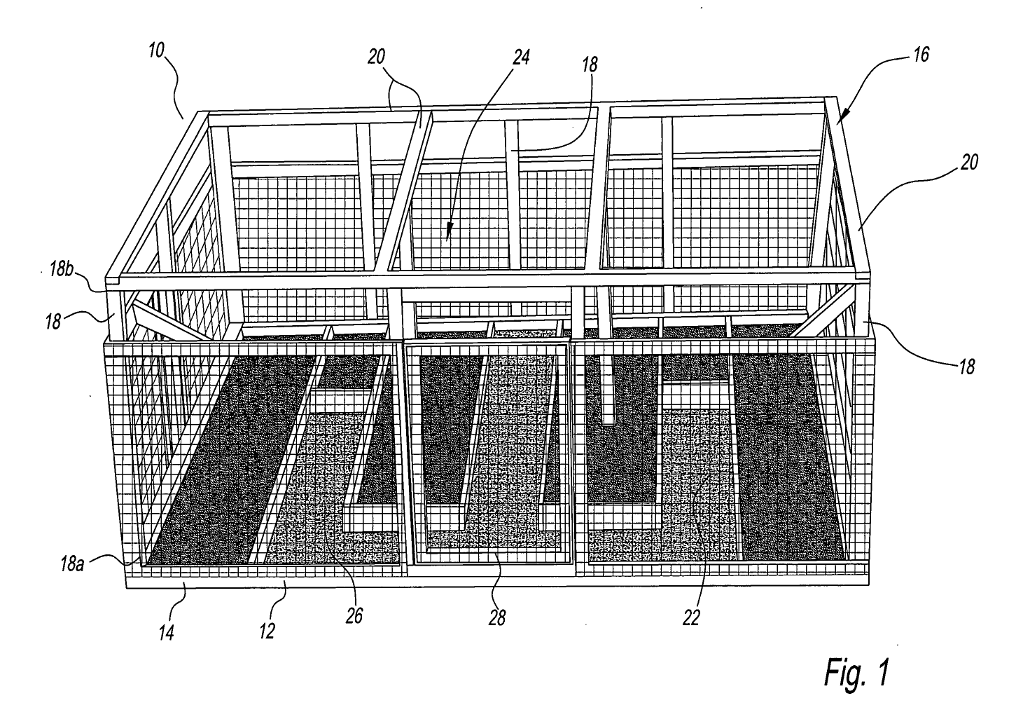

Referring to the drawings and particularly to FIG. 1, there is illustrated a raised-bed gardening structure of the present invention generally represented by reference number 10. Raised-bed gardening structure 10 has a frame 16 including a base 12. The base 12 may be formed by a single member or by a plurality of connected members. In the preferred embodiment shown in FIG. 1, a plurality of straight, interconnected members 14 form base 12.

Frame 16 has a plurality of vertical support members 18 and a plurality of cross members 20. Each vertical support member 18 has a bottom end 18a and a top end 18b. Each vertical support member 18 is connected to base 12 at bottom end 18a and connected to at least one cross member 20 at or near the top end 18b. Frame 16 should extend from approximately 3 feet to approximately 9 feet above ground level. Preferably, frame 16 extends from approximately 6 feet to approximately 8 feet above ground level. In the preferred embodiment shown in FIG. 1, frame 16 is substantially rectangular. However, frame 16 may alternatively be of any shape, including, but not limited to, an elliptical shape, a circular shape, a polygonal shape, or an irregular shape.

In one preferred embodiment, base 12, vertical support members 18, and cross members 20 are made of wood, and may be connected using wood joinery techniques. This embodiment is advantageous because it limits the amount of exposed metal that may cause injury or be susceptible to rust and corrosion. Alternatively, base 12, vertical support members 18, and cross members 20 may be made of metal, plastic, ceramic, composite material, or any combination thereof.

Traditionally, moving a garden plot was difficult. The present invention solves this problem by allowing the entire raised-bed gardening structure 10 to be disassembled and relocated. Preferably, vertical support members 18 are removably connected to base 12 and removably connected to cross members 20 to allow the entire raised-bed gardening structure 10 to be moved if desired. Vertical support members 18 and cross members 20 are removably connected using fasteners, including, but not limited to, one or more screws, bolts, clamps, latches, pins or nails. Using basic household hand and power tools, the entire raised-bed gardening system 10 can be disassembled and relocated.

Referring to FIG. 1, a fence 22 is connected to the perimeter of frame 16 to form a gardening enclosure 24. Fence 22 should be tall enough to effectively prevent deer and other large animals from entering the garden. For example, to keep deer from eating or otherwise destroying the garden, fence 22 should be tall enough to prevent the deer from reaching over or jumping over the fence. Fence 22 can extend between approximately 5 and approximately 9 feet above ground level. Preferably, fence 22 extends between approximately 5 and approximately 8 feet above ground level.

Fence 22 may be made up of any material suitable for keeping animals out of the gardening enclosure. Examples of such material include metal fencing, plastic fencing, vinyl-covered welded metal fencing, chicken wire, clear plastic sheeting or any combination of these materials. In the preferred embodiment shown in FIG. 1, fence 22 is divided into discrete panels 26 and connected to the perimeter of frame 16. In an alternative embodiment, a continuous roll of fencing material is connected to the perimeter of frame 16 to form fence 22. Fence 22 may also serve as a support for trellising plants. In another alternative embodiment, a continuous roll of plastic, or individual plastic panels, is connected to the fencing material to shield the garden enclosure from wind and/or to trap solar heat.

Fence 22 preferably has a gate 28 to allow for access to gardening enclosure 24. Gate 28 should be wide enough to allow the gardener to comfortably enter and exit the gardening enclosure. Preferably, gate 28 is between approximately 32 and approximately 52 inches wide.

Fence 22 together with frame 16 form a gardening enclosure 24 that, in the preferred embodiment shown in FIG. 1, is open at the top, allowing tall plants to grow unrestricted, and sunlight to reach gardening enclosure 24. The open-top construction also allows for the placement of a bird net, a sunshade or a clear plastic cover if desired.

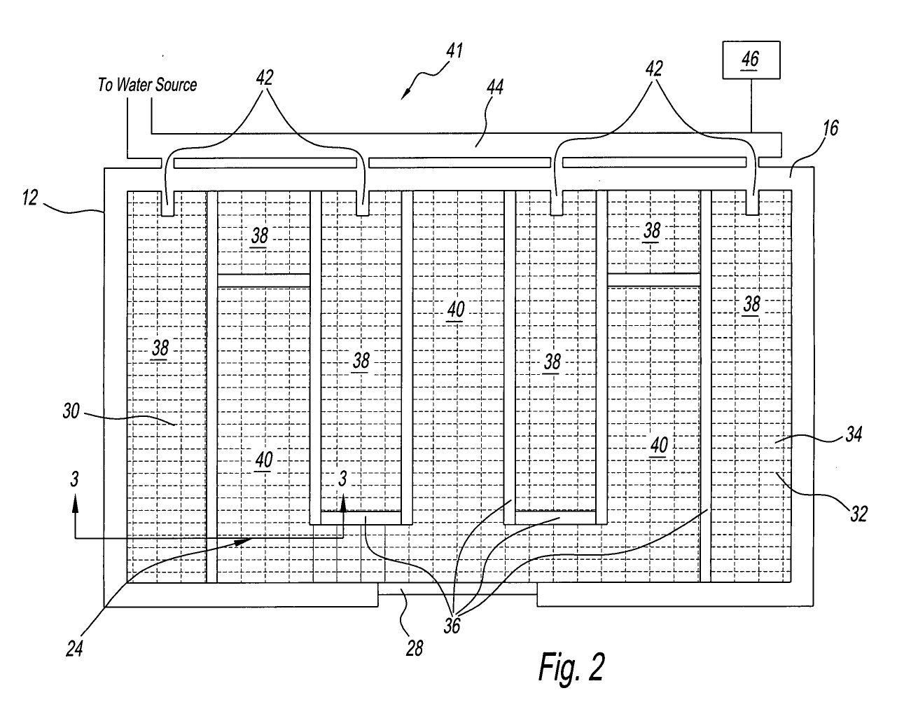

Referring to FIG. 2, a grid assembly 30 is connected to base 12 to prevent burrowing animals from entering the garden. Traditionally, a garden fence had to extend below ground to discourage animals who might try digging or burrowing into the garden. Extending a fence deep enough into the ground to prevent burrowing can be labor intensive, and may not be completely effective. The present invention solves this problem by providing grid assembly 30 connected to base 12. Together with fence 22, grid assembly 30 forms a protective barrier preventing both large and small animals from entering gardening enclosure 24. In the preferred embodiment shown, grid assembly 30 is formed by two or more heavy-gauge wires 32 intersecting at substantially right angles and welded together at each point of intersection, to form substantially rectangular grid openings 34. Grid openings 34 should be small enough to prevent all types of burrowing animals from passing through the grid assembly 30. Preferably, grid openings 34 are about 2 inches apart in one direction and about 1 inch apart in the other direction.

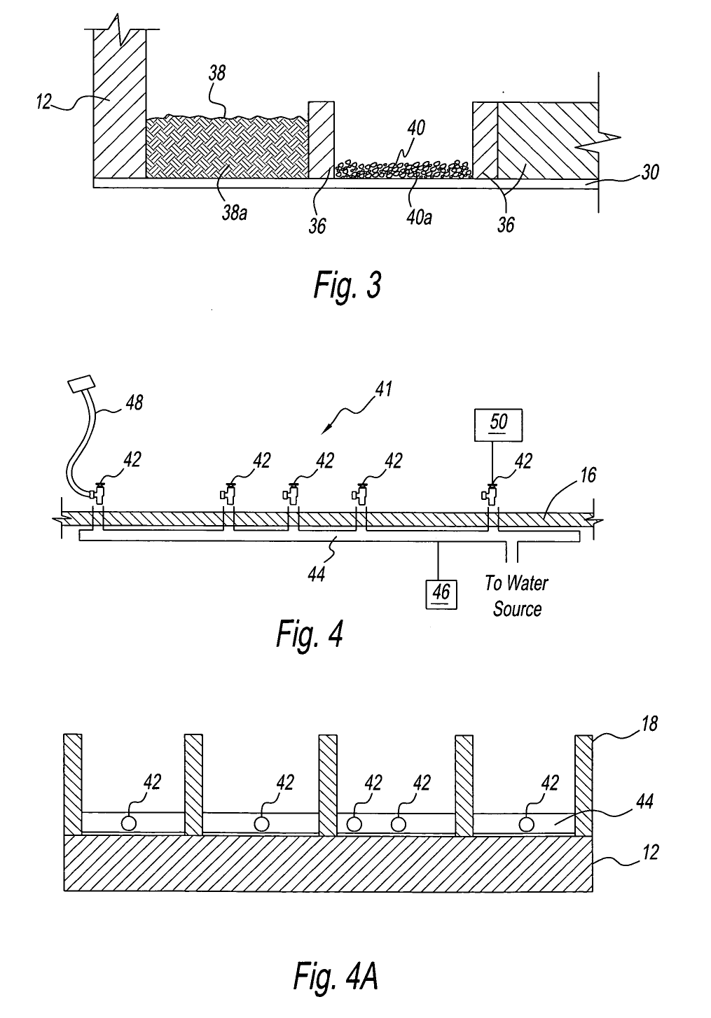

Referring to FIGS. 2 and 3, two or more interconnected sidewalls 36 are positioned above grid assembly 30 and in gardening enclosure 24. Together with base 12, sidewalls 36 form raised garden beds 38 and walkways 40 adjacent to the raised garden beds. In the preferred embodiment shown in FIG. 2, gardening enclosure 24 has six raised garden beds 38 of varying areas with walkways 40 adjacent to each raised bed. Alternatively, a smaller or a larger number of beds 38 and walkways 40 could be used.

Referring to FIG. 3, garden beds 38 may be filled with plant-sustaining material 38a and walkways 40 may be covered with fill 40a, so as to completely conceal grid assembly 30. Garden beds 38 may be filled with any type of plant-sustaining material, such as soil, peat moss, or mulch, and should be filled to a depth sufficient to sustain plant growth. Fill 40a used to cover walkways 40 may be any known filler material, such as, for example, rocks, gravel, bark, or any other suitable material. The depth of plant-sustaining material 38a should be substantially higher than the depth of fill 40a so as to form garden beds 38 that are substantially raised. Raised garden beds 38 prevent the gardener from having to bend down as far to cultivate and tend the garden, thereby reducing the risk of back strain or other injury. Advantageously, tending of raised garden beds 38 can be accomplished from adjacent walkways 40, preventing soil compaction and allowing the gardener to tend the garden during wet or rainy conditions.

Walkways 40 should be wide enough to allow the gardener to comfortably tend the garden. Preferably, sidewalls 36 are between approximately 6 and approximately 24 inches in height. More preferably, sidewalls 36 are between approximately 12 and approximately 18 inches high. Each garden bed 38 is preferably between approximately 20 and approximately 40 inches wide and between approximately 5 and approximately 15 feet long. More preferably, each garden bed 38 is approximately 30 inches wide and approximately 12 feet long. Each walkway 40 is preferably between approximately 12 and approximately 48 inches wide. More preferably, each walkway is between approximately 18 and approximately 22 inches wide. Preferably, garden beds 38 and walkways 40 are configured in gardening enclosure 24 as shown in FIG. 2 or in a manner analogous to the configuration shown in FIG. 2. These dimensions and configurations allow each garden bed 38 to be readily attended to from a walkway 40.

In an alternate embodiment of the present invention, the raised-bed gardening structure is wheelchair accessible. That is, walkways 40 are wide enough to allow a person in a wheelchair to comfortably maneuver within gardening enclosure 24, and the width of garden beds 38 and the height of sidewalls 36 are such that the garden beds can be readily attended by a person in a wheelchair. Additionally, a ramp may be added to the gardening structure to allow ingress and egress into the gardening enclosure by a person in a wheelchair.

Referring to FIGS. 2, 4, and 4A, a water delivery system 41 includes at least one faucet 42 positioned in close proximity to each of raised garden beds 38. As shown in FIG. 2, each faucet 42 extends into gardening enclosure 24 and is connected to a water source outside of the raised-bed gardening structure 10.

If more than one raised-garden bed 38 is present, faucets 42 may be connected to a manifold 44. Manifold 44 may be connected to frame 16 of the raised-bed gardening structure 10, and is connected to an external water source (not shown). Although manifold 44 is connected to the exterior of frame 16 in the preferred embodiment shown in FIGS. 4 and 4A, manifold 44 may alternatively be connected to the interior of frame 16. Water delivery system 41 allows each raised garden bed 38 to be watered independently using only a single water source. In an alternative embodiment, manifold 44 is also connected to at least one electronic timer 46, to allow a predetermined amount of water to be delivered to each raised garden bed 38 at certain intervals. Referring to FIG. 4, in one embodiment, one of the faucets 42 may be connected to a hose 48, to allow the gardener to water the garden manually. In yet another embodiment, faucet 42 is connected to an overhead sprinkler 50.

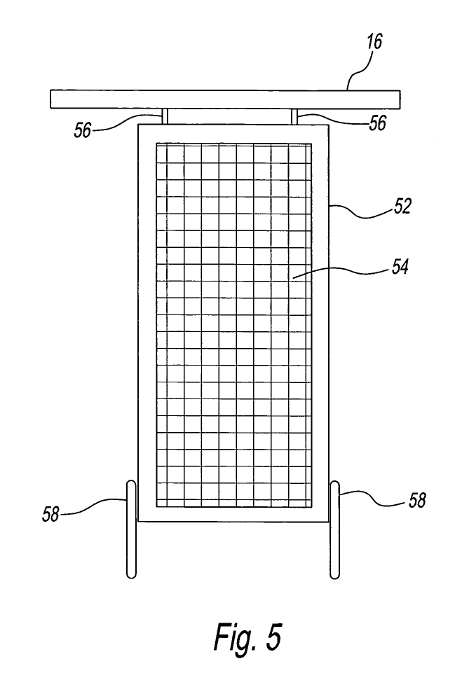

Referring to FIG. 5, a hanging, removable trellis rack 52 may be suspended from at least one cross-members 20. Trellis rack 52 has a trellis fence panel 54 with a top and a bottom, fasteners 56 to connect the top of trellis fence panel 54 to cross-member 20, and one or more adjustable support legs 58 connected to the bottom of trellis fence panel 54. Alternatively, other accessories may be attached to cross-member 20 in a similar manner.

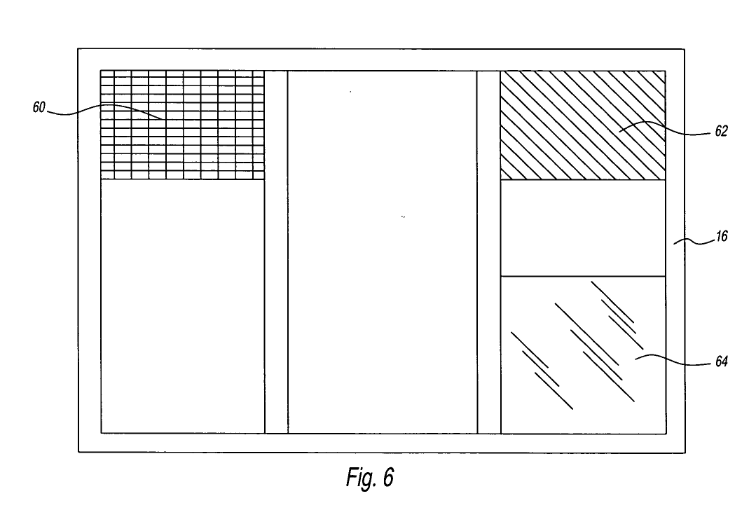

As illustrated in FIG. 6, the open-top construction allows for the placement of a bird net 60, a sunshade 62 or a plastic panel 64. Bird net 60, sunshade 62 or plastic panel 64 may be placed over substantially all of the open top of frame 16 or over a portion of the open top of frame 16.

In an alternate embodiment of raised-bed gardening structure 10, fence 22 comprises plastic sheeting or paneling, and is combined with plastic panel 64 to create a greenhouse effect within gardening enclosure 24.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What I claim is:

1. A raised-bed gardening structure comprising:
a frame having a perimeter, the frame comprising a base, a plurality of vertical support members connected to the base, and a plurality of cross members connected to the vertical support members;
a grid assembly being connected to the base;
a fence being connected to the perimeter of the frame and forming a gardening enclosure;
a plurality of interconnected sidewalls positioned above the grid assembly to form at least one raised garden bed and at least one walkway.

2. The structure of claim 1, further comprising a water delivery system having at least one faucet extending into the gardening enclosure, and a manifold for connecting the at least one faucet to a water source.

3. The structure of claim 2, further comprising an electronic timer for controlling the flow of water into the manifold.

4. The structure of claim 2, wherein the at least one faucet is positioned in close proximity to the at least one raised garden bed.

5. The structure of claim 2, further comprising an overhead sprinkler connected to the at least one faucet.

6. The structure of claim 1, further comprising a removable hanging trellis rack for connection to the frame.

7. The structure of claim 1, further comprising a bird net for connection to the frame and for extending over at least part of the frame.

8. The structure of claim 1, further comprising a sunshade for connection to the frame and for extending over at least part of the frame.

9. The structure of claim 1, further comprising a plastic panel for connection to the frame and for extending over at least part of the frame.

10. The structure of claim 1, wherein the grid assembly is formed by a plurality of wires intersecting at substantially right angles and forming substantially rectangular grid openings.

11. The structure of claim 9, wherein the substantially rectangular grid openings are about 2 inches apart in one direction and about 1 inch apart in the other direction.

12. The structure of claim 1, wherein the sidewalls are approximately 6 inches to approximately 24 inches high.

13. The structure of claim 1, wherein the frame extends approximately 3 feet to approximately 9 feet above ground level.

14. The structure of claim 1, wherein the at least one raised garden bed is approximately 5 feet to approximately 18 feet in length.

15. The structure of claim 1, wherein the at least one raised garden bed is approximately 20 inches to approximately 40 inches wide.

16. The structure of claim 1, wherein the at least one walkway is approximately 12 inches to approximately 48 inches wide.

17. The structure of claim 1, wherein the vertical support members and cross members are made of a material selected from the group consisting of wood, metal, plastic, ceramic, composite, and any combination thereof.

18. The structure of claim 1, wherein the fence is made of a material selected from the group consisting of metal fencing, plastic fencing, chicken wire, plastic sheeting, plastic panels, or any combination thereof.

19. The structure of claim 1, wherein the fence has a gate for ingress and egress into the gardening enclosure.

20. The structure of claim 1, wherein the gate is approximately 32 inches to approximately 52 inches wide.

21. The structure of claim 1, wherein the structure is wheelchair accessible.

22. A raised-bed gardening structure comprising
a base;
a grid assembly being connected to the base;
a frame being removably connected to the base, the frame having a plurality of vertical support members connected to a plurality of cross members;
a fence being removably connected to the frame and forming a gardening enclosure, the fence having a gate for ingress and egress into the gardening enclosure;
a plurality of interconnected sidewalls being positioned above the grid assembly and thereby forming at least one raised garden bed and at least one walkway;
a water delivery system having at least one faucet extending into the gardening enclosure, and a manifold for connecting the faucet to a water source.

23. The structure of claim 20, wherein the frame is connected to the base using fasteners selected from the group consisting of screws, bolts, clamps, latches, pins, nails, and any combination thereof.
